(19) United States
(12) Patent Application Publication
(10) Pub. No.: US 2019/0364885 A1
(43) Pub. Date: Dec. 5, 2019

(54) METHODS AND COMPOSITIONS FOR FEEDING PIERCING AND SUCKING INSECTS

(71) Applicant: ABGIOME, INC., Durham, NC (US)

(72) Inventor: Hai Van Tran, Wake Forest, NC (US)

(73) Assignee: ABGIOME, INC., Durham, NC (US)

(21) Appl. No.: 16/478,003

(22) PCT Filed: Jan. 12, 2018
(86) PCT No.: PCT/US2018/013515

§ 371 Date: Jul. 15, 2019

Related U.S. Application Data
(60) Provisional application No. 62/446,660, filed on Jan. 16, 2017.

(51) Int. Cl. A01N 25/00; G01N 33/569; G01N 33/68; A01M 1/20

(52) U.S. Cl. CPC A01N 25/006; A01M 1/2005; G01N 33/68; G01N 33/569

(57) ABSTRACT

Methods and compositions are provided for evaluating the insect resistance of an agent of interest. Specifically, a feeding apparatus is provided for evaluation of the insecticidal activity of an agent of interest in a liquid diet solution against a piercing or sucking insect. Further provided are methods for feeding a piercing or sucking insect a liquid diet having an agent of interest in order to evaluate the insecticidal activity of the agent.

### FIELD OF THE INVENTION

The present invention relates to the field of insect resistance and pest management.

### BACKGROUND OF THE INVENTION

Plant pests, including piercing and sucking insect pests, are a major factor in the loss of the world's agricultural crops. Agriculturally significant piercing and sucking insects include the southern green stink bug (Nezara viridula), brown marmorated stink bug (Halyomorpha halys) and kudzu bug (Megacopta cribraria). Stink bugs are phytophagous pentatomids, with a wide host range including plants with growing shoots and developing seeds or fruits. Other piercing or sucking insect pests include aphids and mosquitoes. In addition to the agricultural impact, piercing or sucking insects can cause injury and even death by their bites or stings. Additionally, many pests transmit bacteria and other pathogens that cause diseases in humans and animals. For example, mosquitoes transmit pathogens that cause malaria, yellow fever, encephalitis, and other diseases. The bubonic plague, or black death, is caused by bacteria that infect rats and other rodents.

Simple and effective means for the evaluation of insecticidal agents in liquid solution are needed for the particular challenges of piercing and sucking insects.

### BRIEF SUMMARY OF THE INVENTION

Methods and compositions are provided for evaluating the insect resistance of an agent of interest. Specifically, a feeding apparatus is provided for evaluation of the insecticidal activity of an agent of interest in a liquid diet solution against a piercing or sucking insect. Further provided are methods for feeding a piercing or sucking insect a liquid diet having an agent of interest in order to evaluate the insecticidal activity of the agent.

### BRIEF DESCRIPTION OF THE FIGURES

FIG. 1 presents data on stink bug mortality using the capillary tube ingestion bioassay. Stink bugs exhibited low mortality (15%) at Day 4 when provided a liquid diet alone. High mortality (100%) was observed at Day 4 when stink bugs were fed diet +5 ppm imidacloprid insecticide. High mortality (100%) was observed at Day 4 when stink bugs were provided water without diet. Data was collected on two replicates with 5 insects per replicate.

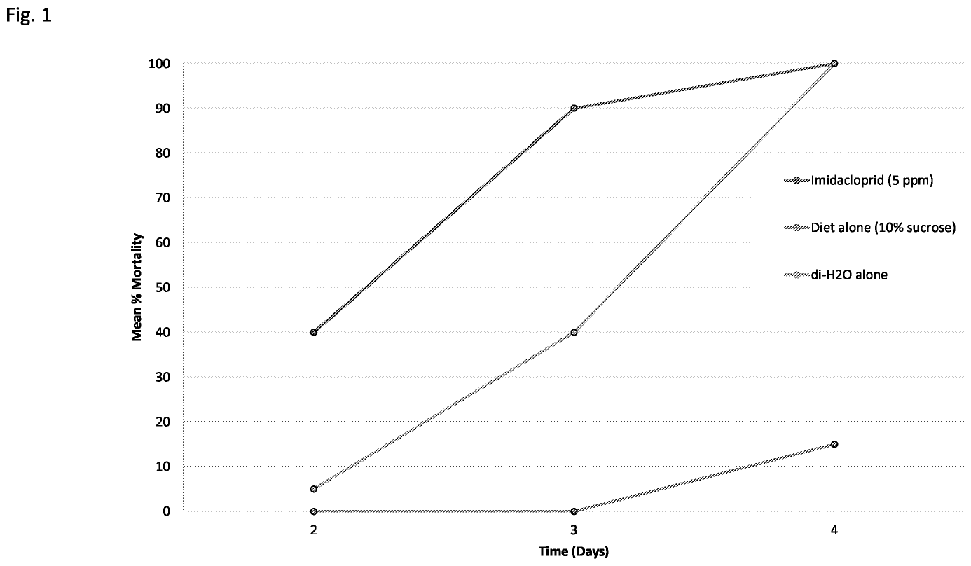

FIG. 2 shows stink bug mortality on days 5-7 when provided 10% sucrose +Nystatin in capillary tubes. The addition of nystatin antifungal does not increase stink bug mortality as nystatin concentration increases.

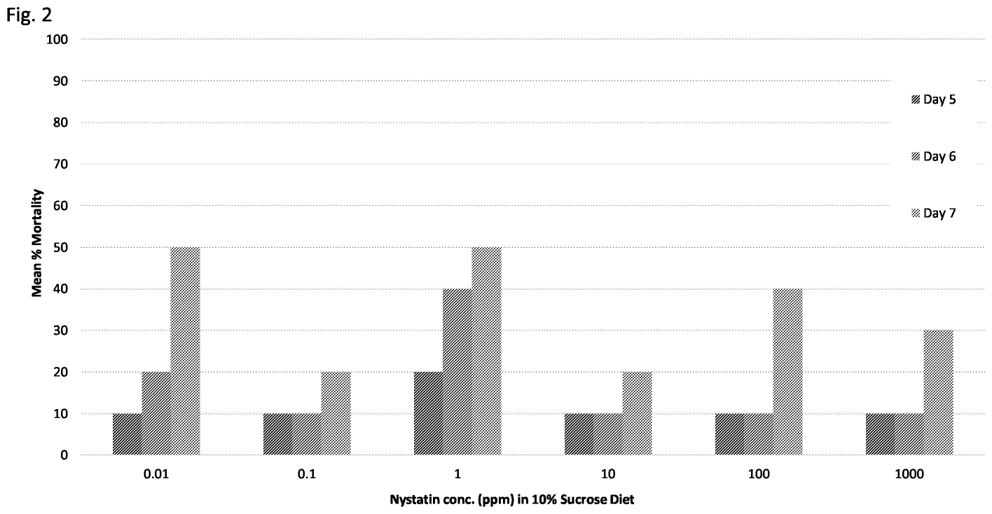

FIG. 3 compares control mortality of SGSB using 24-well plates and capillary tube formats. Mortality for each treatment was similar between formats.

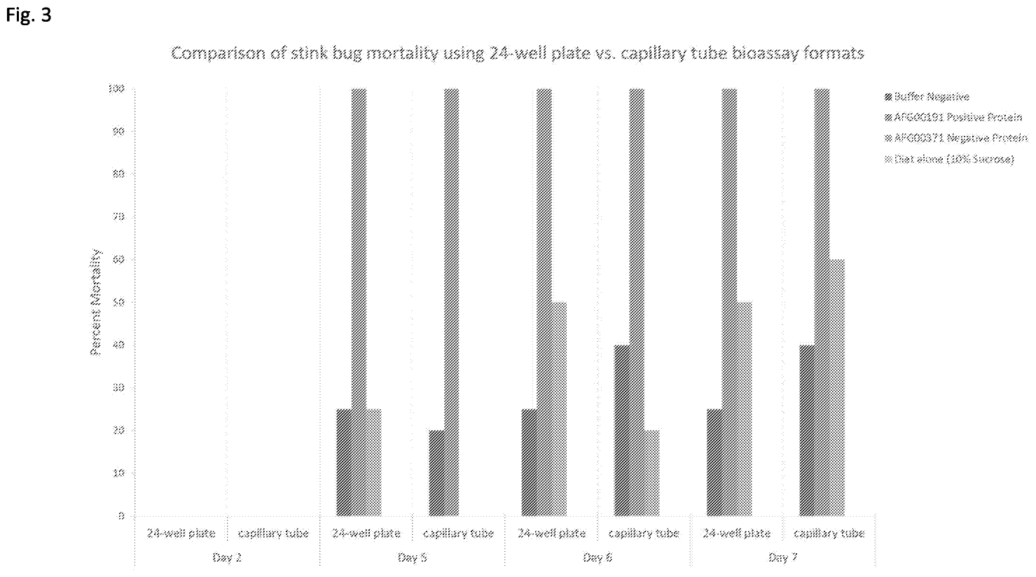

FIG. 4 shows a piercing insect feeding on a liquid diet solution through a hole in a capillary tube.

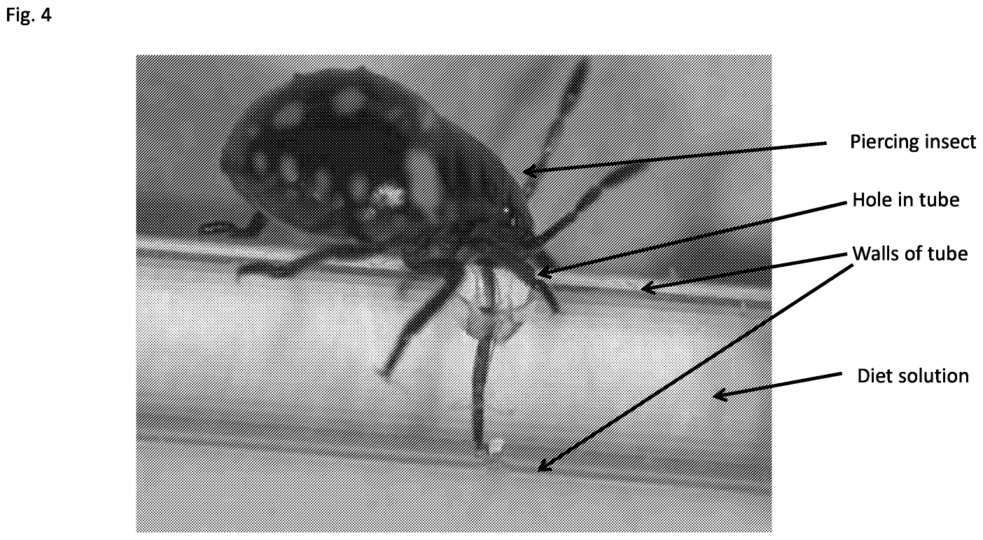

### DETAILED DESCRIPTION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### I. Overview

The methods described herein are useful for evaluating the insecticidal activity of an agent of interest against sucking and piercing insects. Insecticidal agents can be any agent capable of being delivered to an insect in a liquid. For example, an insecticidal agent could be a protein, nucleic acid (e.g., interfering nucleic acid), microorganism, or cell lysate, among others. The lysate can be a lysate of any cell expressing an insecticidal agent or potentially insecticidal agent. In particular embodiments, the cell lysate can be the lysate of Escherichia coli or Bacillus thuringiensis modified to express an insecticidal agent.

In some embodiments, the compositions and methods disclosed herein are used to deliver an agent with no insecticidal activity to an insect for the purposes of determining the insecticidal activity of the agent. As used herein, insecticidal activity refers to the ability of an agent, when consumed by an insect, to prevent the insect from surviving as long as the insect would have survived consuming the same diet, but without having consumed the agent of interest.

### II. Feeding Apparatus

Compositions and methods disclosed herein utilize a feeding apparatus to deliver a liquid diet solution containing a potentially insecticidal agent to a piercing or sucking insect. The feeding apparatus can include a feeding tube having holes and a diet solution for a piercing or sucking insect. In addition to the insecticidal agent, or potentially insecticidal agent, the diet solution can include sugars or other essential food sources for the particular piercing or sucking insect. For example the diet solution can comprise about 5%, about 10%, or about 15% sugar solution, such as glucose, sucrose, fructose, or mannose among others. In specific embodiments, the diet solution comprises about 10% sucrose. The diet solution can contain amino acids in a concentration sufficient to prevent mortality of the insect. In some embodiments, the diet solution comprises about 10% sucrose and amino acids. Any liquid can be used to deliver the agent of interest to an insect, including, but not limited to, water. The delivery liquid for the agent of interest can also include any appropriate buffer or food source that does not interfere with the insecticidal activity of the agent of interest. The amount of diet solution used in the feeding assay can vary based on the size of the feeding tube used. In specific embodiments, about 10 μl, 15 μl, 16 μl, 17 μl, 18 μl, 19 μl, 20 μl, 21 μl, 22 μl, 23 μl, 24 μl, 25 μl, 26 μl, 27 μl, 28 μl, 29 μl, 30 μl, 35 μl, 40 μl, 45 μl, 50 μl, 60 μl, 70 μl, 80 μl, or 100 μl of diet solution is added to the feeding tube.

In some embodiments, an antimicrobial or antifungal composition is added to the diet solution in order to prevent contamination of the feeding solution with bacteria or fungi. For example, the diet solution can contain Nystatin at a concentration of about 500 ppm, 750 ppm, 900 ppm, 1000 ppm, 1100 ppm, 1250 ppm, or 1500pm.

The liquid diet solution is delivered to the piercing or sucking insect from within a tube having holes through which the insect can access the diet solution. Any tube capable of containing a liquid can be used to deliver the liquid diet solution to the insect. The tube can be made of plastic, rubber, metal, or any other material capable of holding a liquid solution. For example, the tube can be any type of plastic such as, styrene (HIPS), PETG or polyethylene. The walls of the tube should be of sufficient thickness to allow a piercing or sucking insect to feed on the diet solution contain within the tube. In some embodiments, the walls of the tube are about 0.010 mm, about 0.10 mm, about 0.20 mm, about 0.30 mm, about 0.40 mm, about 0.50 mm, about 0.60 mm, about 0.70 mm, about 0.80 mm, about 0.90 mm, about 1.0 mm, about 1.10 mm, about 1.25 mm, about 1.50 mm, or about 2.0 mm or more.

The tube can be of any length that allows at least one insect to feed on the tube. In some embodiments, the tube is about 20 mm, about 25, about 30, about 35 mm, about 40 mm, about 45 mm, about 50 mm, about 55 mm, about 60 mm, about 65 mm, about 70 mm, about 75 mm, about 80 mm, about 85 mm, about 90 mm, about 95 mm, about 100 mm, about 125 mm, about 150 mm, about 175 mm, or about 200 mm or more. In some embodiments the tube is of sufficient length to fit within a feeding container, such as within a standard Petri dish (about 100 mm diameter). In some embodiments, the tube is a plastic capillary tube having an interior diameter of about 0.90 mm, an outer diameter of about 1.60 mm, and a wall thickness of about 0.70 mm.

The tube can be closed at one or both ends in order to prevent the liquid solution from draining. Any material can be used to close the ends of the tube including an end cap, plastic film, plastic paraffin film, or wax among others. Alternatively, the tube can be heated to melt the ends of the tube closed. Extra liquid can be added to the feeding container in order to prevent evaporation of the diet solution from the feeding tube. In some embodiments, about 0.2 mL, about 0.4 mL about 0.5 mL about 0.6 mL about 0.7 mL about 1.0 mL of water is added to the feeding container with the feeding tube. Water used in the assay can be from any source or composition and can be be purified to reduce the microbial content and/or other contamination. In specific embodiments, the water is deionized water (diH2O), reverse osmosis water (roH2O), filtered water, distilled water, spring water, or tap water. In some embodiments, the water can be autoclaved prior to use in the feeding assay disclosed herein. The water added to the feeding container can be added directly to the container or can be added to an absorbent material in the container. In some embodiments, autoclaved water is added to a filter pad or filter paper in the feeding container. The extra liquid can be added to the feeding container prior to or after addition of the insects. In some embodiments, the extra liquid is added to a Petri dish pad inside or outside of the Petri dish feeding container. In specific embodiments, autoclaved water can be added to filter paper outside of the Petri dish feeding container, and then transferred to the feeding container.

One or more holes can be located in the feeding tube to allow a piercing or sucking insect to feed on the diet solution contained within the tube. The holes in the tube should be of sufficient diameter to allow a piercing or sucking insect to feed on the diet solution. Thus, the diameter of the holes could vary based on the ability of the particular piercing or sucking insect to access the diet solution. In specific embodiments, the holes can be made in the tube using a dissecting needle or teasing needle, such as a 19 gauge teasing needle. The holes in the tube can be less than about 0.5 mm, or about 0.5 mm, about 0.6 mm, about 0.7 mm, about 0.8 mm, about 0.9 mm, about 1.0 mm, about 1.1 mm, about 1.2 mm, about 1.3 mm, about 1.4 mm, about 1.5 mm, about 1.7 mm, about 2.0 mm, about 2.5 mm, about 3.0 mm, or more or about 0.5 mm to about 2.0 mm, about 0.8 to about 1.4 mm, or about 0.9 mm to about 1.2 mm.

The tube can have 1, 2, 3, 4, 5, 6, 7, 8, 9, 10, 11, 12, 13, 14, 15, 20, 25, 30, or more holes. When more than one hole is located in the tube, the holes can be located a sufficient distance from each other to allow multiple piercing or sucking insects to feed simultaneously from different holes. For example, the holes can be located at least 2 mm, at least 3 mm, at least 4 mm, at least 5 mm, at least 6 mm, at least 7 mm, at least 8 mm, at least 9 mm, at least 10 mm, at least 12 mm, at least 15 mm, or at least 2-20 mm, at least 4-15 mm, at least 6-12 mm, or at 8-10 mm from each other.

In particular embodiments, the tube is located within a feeding container. Any feeding container can be used to prevent escape of the piercing or sucking insect and allow access of the insect to the feeding tube and diet solution. In specific embodiments, the feeding container allows air to access the interior of the container (i.e., is not airtight). For example, the feeding container can be a Petri dish into which the feeding tube and piercing or sucking insect is placed. In some embodiments, more than one feeding tube can be located within a single feeding container. For example a feeding container can contain 2, 3, 4, or 5 feeding tubes, as described herein.

### III. Methods of Feeding

The feeding apparatus described herein can be used to feed piercing or sucking insect in order to evaluate the insecticidal activity of an agent of interest. Any piercing or sucking insect can be placed in a feeding container comprising the tube with a diet solution described herein. Insects can be placed in the feeding container or on the feeding apparatus using any means proper for transferring piercing or sucking insects without injuring the insects. For example, the insects can be placed in the feeding container using feathertip forceps or a vacuum aspirator. In some embodiments an insect of interest is infested onto a plant of interest using a moistened camel hair brush such that the insect of interest is not injured and the plant of interest in not injured. Optionally, carbon dioxide gas can be used to knock down, stun, or anesthetize the insects prior to infesting. Alternatively, any other chemical or mechanical means can be used to knock down the insects prior to infesting.

Any species of piercing or sucking insect or a combination of species can be placed in the feeding container. In some embodiments, at least 2, at least 3, at least 4, at least 5, at least 6, at least 7, at least 8, at least 9, at least 10, at least 12, at least 15, at least 2-11, at least 4-10, or at 6-8 insects are placed in the feeding container. In specific embodiments, 5 insects are placed in the feeding container for the feeding assay. In specific embodiments, the size of all insects in a single feeding container is consistent such that larger insects do not cannibalize smaller insects. For example, the size of each insect can be within 50%, 60%, 70%, 75%, 80%, 85%, 90%, 95%, 98% or more, when compared to each other insect in a single feeding container. Insect size can refer to the height, weight, circumference, or any other objective or subjective measure of insect size.

Insects employed in the method disclosed herein can be used at any stage of development wherein the insect is capable of utilizing liquid diet as a food source. For example, insects can be used after the first instar, during the second instar, third instar, fourth instar, fifth instar, or any other developmental or adult growth stage. As used herein, the term “instar” is used to denote the developmental stage of the larval or nymphal forms of insects. In specific embodiments, brown marmorated stink bugs or southern green stink bugs are selected at the second instar stage for use in the method disclosed herein. In other embodiments, kudzu bugs are selected at the fourth instar stage for use in the method disclosed herein. In specific embodiments, lygus insects are selected at the third instar stage for use in the methods disclosed herein. In some embodiments aphids are selected at the adult growth stage for use in the methods disclosed herein.

As used herein a piercing or sucking insect has mouthparts specifically designed for piercing and sucking. Piercing and sucking insects are particularly capable of damaging plant tissue by inserting their mouthparts into plant tissue and removing juices. Heavily infested plants become yellow, wilted, deformed or stunted, and may eventually die. Some sucking insects inject toxic materials into the plant while feeding, and some transmit disease organisms. Example of piercing and sucking insects include, but are not limited to: aphids, leafhoppers, stinkbugs, tarnished plant bugs, squash bugs, thrips, spider mites, and mosquitoes. In specific embodiments, insects used in the methods disclosed herein can be selected from the orders Coleoptera, Diptera, Hymenoptera, Lepidoptera, Mallophaga, Homoptera, Hemiptera, Orthoptera, Thysanoptera, Dermaptera, Isoptera, Anoplura, Siphonaptera, Trichoptera, etc., particularly Hemiptera. In some embodiments, insect pests include Pentatomidae insects. As used herein, the term “insect” refers to an insect at any stage of development, including an insect nymph and an adult insect.

Insect pests for major crops include: Soybean: Aphis glycines, Soybean aphid; Euschistus (E. biformis, E. integer, E. quadrator, E. servus, E. tristigma), Brown stinkbug; Piezodorus guildinii, red banded stink bug; Pseudoplusia includens, soybean looper; Anticarsia gemmatalis, velvetbean caterpillar; Plathypena scabra, green cloverworm; Ostrinia nubilalis, European corn borer; Agrotis ipsilon, black cutworm; Spodoptera exigua, beet armyworm; Heliothis virescens, cotton budworm; Helicoverpa zea, cotton bollworm; Epilachna varivestis, Mexican bean beetle; Myzus persicae, green peach aphid; Empoasca fabae, potato leafhopper; Acrosternum hilare, green stink bug; Nezara viridula, Southern green stink bug; Halyomorpha halys, brown marmorated stink bug; Megacopta cribraria, Kudzu bug; Melanoplus femurrubrum, redlegged grasshopper; Melanoplus differentialis, differential grasshopper; Hylemya platura, seedcorn maggot; Sericothrips variabilis, soybean thrips; Thrips tabaci, onion thrips; Tetranychus turkestani, strawberry spider mite; Tetranychus urticae, twospotted spider mite; Maize: Halyomorpha halys, brown marmorated stink bug; Euschistus (E. biformis, E. integer, E. quadrator, E. servus, E. tristigma), brown stinkbug, Acrosternum hilare, green stink bug; Nezara viridula, Southern green stink bug; Bagrada hilaris, Bagrada bug; Ostrinia nubilalis, European corn borer; Agrotis ipsilon, black cutworm; Helicoverpa zea, corn earworm; Spodoptera frugiperda, fall armyworm; Diatraea grandiosella, southwestern corn borer; Elasmopalpus lignosellus, lesser cornstalk borer; Diatraea saccharalis, surgarcane borer; Diabrotica virgifera, western corn rootworm; Diabrotica longicomis barberi, northern corn rootworm; Diabrotica undecimpunctata howardi, southern corn rootworm; pest species in the family Elateridae, including species of the genera Aeolus, Agriotes, Conoderus, Hemicrepidus, and Limonius; Melanotus spp., wireworms; Cyclocephala borealis, northern masked chafer (white grub); Cyclocephala immaculata, southern masked chafer (white grub); Popillia japonica, Japanese beetle; Chaetocnema pulicaria, corn flea beetle; Sphenophorus maidis, maize billbug; Rhopalosiphum maidis, corn leaf aphid; Anuraphis maidiradicis, corn root aphid; Blissus leucopterus leucopterus, chinch bug; Melanoplus femurrubrum, redlegged grasshopper; Melanoplus sanguinipes, migratory grasshopper; Hylemya platura, seedcorn maggot; Agromyza parvicornis, corn blot leafminer; Anaphothrips obscrurus, grass thrips; Solenopsis milesta, thief ant; Tetranychus urticae, twospotted spider mite; Sorghum: Chilo partellus, sorghum borer; Spodoptera frugiperda, fall armyworm; Helicoverpa zea, corn earworm; Elasmopalpus lignosellus, lesser cornstalk borer; Feltia subterranea, granulate cutworm; Phyllophaga crinita, white grub; Eleodes, Conoderus, and Aeolus spp., wireworms; Oulema melanopus, cereal leaf beetle; Chaetocnema pulicaria, corn flea beetle; Sphenophorus maidis, maize billbug; Rhopalosiphum maidis; corn leaf aphid; Sipha flava, yellow sugarcane aphid; Blissus leucopterus leucopterus, chinch bug; Contarinia sorghicola, sorghum midge; Tetranychus cinnabarinus, carmine spider mite; Tetranychus urticae, twospotted spider mite; Wheat: Eurygaster integriceps, Sunn pest; Diuraphis noxia, Russian wheat aphid; Pseudaletia unipunctata, army worm; Spodoptera frugiperda, fall armyworm; Elasmopalpus lignosellus, lesser cornstalk borer; Agrotis orthogonia, western cutworm; Elasmopalpus lignosellus, lesser cornstalk borer; Oulema melanopus, cereal leaf beetle; Hypera punctata, clover leaf weevil; Diabrotica undecimpunctata howardi, southern corn rootworm; Russian wheat aphid; Schizaphis graminum, greenbug; Macrosiphum avenae, English grain aphid; Melanoplus femurrubrum, redlegged grasshopper; Melanoplus differentialis, differential grasshopper; Melanoplus sanguinipes, migratory grasshopper; Mayetiola destructor, Hessian fly; Sitodiplosis mosellana, wheat midge; Meromyza americana, wheat stem maggot; Hylemya coarctata, wheat bulb fly; Frankliniella fusca, tobacco thrips; Cephus cinctus, wheat stem sawfly; Aceria tulipae, wheat curl mite; Sunflower: Suleima helianthana, sunflower bud moth; Homoeosoma electellum, sunflower moth; zygogramma exclamationis, sunflower beetle; Bothyrus gibbosus, carrot beetle; Neolasioptera murtfeldtiana, sunflower seed midge; Cotton: Heliothis virescens, cotton budworm; Helicoverpa zea, cotton bollworm; Spodoptera exigua, beet armyworm; Pectinophora gossypiella, pink bollworm; Anthonomus grandis, boll weevil; Aphis gossypii, cotton aphid; Pseudatomoscelis seriatus, cotton fleahopper; Trialeurodes abutilonea, bandedwinged whitefly; Lygus lineolaris, tarnished plant bug; Melanoplus femurrubrum, redlegged grasshopper; Melanoplus differentialis, differential grasshopper; Thrips tabaci, onion thrips; Franklinkiella fusca, tobacco thrips; Tetranychus cinnabarinus, carmine spider mite; Tetranychus urticae, twospotted spider mite; Rice: Diatraea saccharalis, sugarcane borer; Spodoptera frugiperda, fall armyworm; Helicoverpa zea, corn earworm; Colaspis brunnea, grape colaspis; Lissorhoptrus oryzophilus, rice water weevil; Sitophilus oryzae, rice weevil; Nephotettix nigropictus, rice leafhopper; Blissus leucopterus leucopterus, chinch bug; Acrosternum hilare, green stink bug; Barley: Ostrinia nubilalis, European corn borer; Agrotis ipsilon, black cutworm; Schizaphis graminum, greenbug; Blissus leucopterus leucopterus, chinch bug; Acrosternum hilare, green stink bug; Euschistus servus, brown stink bug; Delia platura, seedcorn maggot; Mayetiola destructor, Hessian fly; Petrobia latens, brown wheat mite; Oil Seed Rape: Brevicoryne brassicae, cabbage aphid; Phyllotreta cruciferae, Flea beetle; Mamestra configurata, Bertha armyworm; Plutella xylostella, Diamond-back moth; Delia ssp., Root maggots.

As used herein “Pentatomidae insects” is used to refer to any member of the Pentatomidae family. Accordingly, the methods disclosed herein are also useful in evaluating plant resistance to any Pentatomidae insect including representative genera and species such as, but not limited to, Acrocorisellus (A. serraticollis), Acrosternum (A. adelpha, A. hilare, A. herbidum, A. scutellatum), Agonoscelis (A. nubila), Alcaeorrhynchus (A. grandis, A. phymatophorus), Amaurochrous (A. brevitylus), Apateticus (A. anatarius, A. bracteatus, A. cynicus, A. lineolatus, A. marginiventris), Apoecilus, Arena (A. custos), Arvelius, Bagrada, Banasa (B. calva, B. dimiata, B. grisea, B. induta, B. sordida), Brochymena (B. affinis, B. cariosa, B. haedula, B. hoppingi, B. sulcata), Carbula (C. obtusangula, C. sinica), Chinavia, Chlorochroa (C. belfragii, C. kanei, C. norlandi, C. senilis, C. viridicata), Chlorocoris (C. distinctus, C. flaviviridis, C. hebetatus, C. subrugosus, C. tau), Codophila (C. remota, C. sulcata, C. varius), Coenus (C. delius, C. inermis, C. tarsalis), Cosmopepla (C. bimaculata, C. binotata, C. carnifex, C. decorata, C. intergressus), Dalpada (D. oculata), Dendrocoris (D. arizonesis, D. fruticicola, D. humeralis, D. parapini, D. reticulatus), Dolycoris (D. baccarum (sloe bug)), Dybowskyia (D. reticulata), Edessa, Erthesina (E. fullo), Eurydema (E. dominulus, E. gebleri (shield bug), E. pulchra, E. rugosa), Euschistus (E. biformis, E. integer, E. quadrator, E. servus, E. tristigma), Euthyrhynchus (E. floridanus, E. macronemis), Gonopsis (G. coccinea), Graphosoma (G. lineatum (stinkbug), G. rubrolineatum), Halyomorpha (H. halys (brown marmorated stinkbug)), Halys (H. sindillus, H. sulcatus), Holcostethus (H. abbreviatus, H. fulvipes, H. limbolarius, H. piceus, H. sphacelatus), Homalogonia (H. obtusa), Hymenarcys (H. aequalis, H. crassa, H. nervosa, H. perpuncata, H. reticulata), Lelia (L. decempunctata), Lineostethus, Loxa (L. flavicollis, L. viridis), Mecidea (M. indicia, M. major, M. minor), Megarrhamphus (M. hastatus), Menecles (M. insertus, M. portacrus), Mormidea (M. cubrosa, M. lugens, M. parva, M. pictiventris, M. ypsilon), Moromorpha (M. tetra), Murgantia (M. angularis, M. tessellata, M. varicolor, M. violascens), Neottiglossa (N. californica, N. cavifrons, N. coronaciliata, N. sulcifrons, N. undata), Nezara (N. smaragdulus, N. viridula (southern green stinkbug)), Oebalus (O. grisescens, O. insularis, O. mexicanus, O. pugnax, O. typhoeus), Oechalia (O. schellenbergii (spined predatory shield bug)), Okeanos (O. quelpartensis), Oplomus (O. catena, O. dichrous, O. tripustulatus), Palomena (P. prasina (green shield bug)), Parabrochymena, Pentatoma (P. angulata, P. illuminata, P. japonica, P. kunmingensis, P. metallifera, P. parataibaiensis, P. rufipes, P. semiannulata, P. viridicornuta), Perillus (P. bioculatus, P. confluens, P. strigipes), Picromerus (P. griseus), Piezodorus (P. degeeri, P. guildinii, P. lituratus (gorse shield bug)), Pinthaeus (P. humeralis), Plautia (P. crossota, P. stali (brown-winged green bug)), Podisus (P. maculiventris), Priassus (P. testaceus), Prionosoma, Proxys (P. albopunctulatus, P. punctulatus, P. victor), Rhaphigaster (R. nebulosa), Scotinophara (S. horvathi), Stiretrus (S. anchorago, S. fimbriatus), Thyanta (T. accerra, T. calceata, T. casta, T. perditor, T. pseudocasta), Trichopepla (T. aurora, T. dubia, T. pilipes, T. semivittata, T. vandykei), Tylospilus, and Zicrona.

In some embodiments, the piercing or sucking insect is an insect capable of infesting or injuring humans and/or animals such as, but not limited to those with piercing-sucking mouthparts, as found in Hemiptera and some Hymenoptera and Diptera such as mosquitos, bees, wasps, lice, fleas and ants, as well as members of the Arachnidae such as ticks and mitesorder, class or family of Acarina (ticks and mites) e.g. representatives of the families Argasidae, Dermanyssidae, Ixodidae, Psoroptidae or Sarcoptidae and representatives of the species Amblyomma spp., Anocentor spp., Argas spp., Boophilus spp., Cheyletiella spp., Chorioptes spp., Demodex spp., Dermacentor spp., Denmanyssus spp., Haemophysalis spp., Hyalomma spp., Ixodes spp., Lynxacarus spp., Mesostigmata spp., Notoedres spp., Ornithodoros spp., Ornithonyssus spp., Otobius spp., otodectes spp., Pneumonyssus spp., Psoroptes spp., Rhipicephalus spp., Sarcoptes spp., or Trombicula spp.; Anoplura (sucking and biting lice) e.g. representatives of the species Bovicola spp., Haematopinus spp., Linognathus spp., Menopon spp., Pediculus spp., Pemphigus spp., Phylloxera spp., or Solenopotes spp.; Diptera (flies) e.g. representatives of the species Aedes spp., Anopheles spp., Calliphora spp., Chrysomyia spp., Chrysops spp., Cochliomyia spp., Culex spp., Culicoides spp., Cuterebra spp., Dermatobia spp., Gastrophilus spp., Glossina spp., Haematobia spp., Haematopota spp., Hippobosca spp., Hypoderma spp., Lucilia spp., Lyperosia spp., Melophagus spp., Oestrus spp., Phaenicia spp., Phlebotomus spp., Phormia spp., Sarcophaga spp., Simulium spp., Stomoxys spp., Tabanus spp., Tannia spp. or Tipula spp.; Mallophaga (biting lice) e.g. representatives of the species Damalina spp., Felicola spp., Heterodoxus spp. or Trichodectes spp.; or Siphonaptera (wingless insects) e.g. representatives of the species Ceratophyllus spp., spp., Pulex spp., or Xenopsylla spp; Cimicidae (true bugs) e.g. representatives of the species Cimex spp., Tritominae spp., Rhodinius spp., or Triatoma spp.

Insects can be maintained in the feeding container as long as necessary in order to evaluate the insecticidal activity of the agent of interest in the liquid diet solution. In specific embodiments, the piercing or sucking insect is maintained in the feeding container for at least 3, at least 4, at least 5, at least 6, at least 7, at least 8, at least 9, at least 10, at least 12, at least 13, at least 14, at least 15, at least 16, at least 17, at least 18, at least 19, at least 20, at least 2-18, at least 5-10, at least 6-14, or at least 8-12 days. The length of time in the feeding container can vary depending on the species of insect and/or potentially insecticidal agent under evaluation.

The time that an insect nymph can survive without food changes as the nymph matures. For example, at the second instar stage, a nymph can survive on water without any food source for at least about 5-15 days, 6-12 days, 7-10 days, or 8-9 days. Specifically, a second instar nymph can survive on water without any food source for about 5 days, 6 days, 7 days, 8 days, 9 days, 10 days, 11 days, 12 days, 13 days, 14 days, or 15 days. Similarly, at the fourth or fifth instar stage, a nymph can survive on water without any food source for at least about 8-21 days, 10-18 days, 12-14 days, or 12-16 days. Specifically, a fourth instar nymph can survive on water without any food source for 8 days, 9 days, 10 days, 11 days, 12 days, 13 days, 14 days, 15 days, 16 days, 17 days, 18 days, 19 days, 20 days, or 21 days. The time in which an insect nymph can survive on water, without any food source can vary based on environmental conditions such as a temperature, humidity, and light, among others.

For example, brown marmorated stink bugs and southern green stink bugs at the second instar stage can survive for about 7 days without a food source and kudzu bugs at the fourth instar stage can survive for about 14 days without a food source. Thus, in certain embodiments, brown marmorated stink bugs or southern green stink bugs are selected at the second instar stage, added to a feeding container and maintained in an enclosed environment for at least about 7 days. Insects can be maintained in the feeding container at standard room temperature and humidity conditions. Temperature conditions can range from about 20° C. to about 37° C., including about 23° C., about 24° C., about 25° C., about 26° C., about 27° C., and about 30° C. Relative humidity conditions can range from about 50% to about 90%, 60-80%, 65-75% relative humidity, including at least about 60%, at least about 65%, at least about 70%, at least about 75%, or at least about 80% relative humidity. In specific embodiments, the insets are maintained at 25° C. and at least about 75% relative humidity.

In particular embodiments, the amount of light provided during the feeding assay can be altered to mimic standard day and night conditions. For example, the feeding assay can be conducted with 24:0 day-dark cycle (day:dark cycle), 20:4 day-dark cycle, 18:6 day-dark cycle, 16:8 day-dark cycle, 14:10 day-dark cycle, 12:12 day-dark cycle, 10:14 day-dark cycle, 8:16 day-dark cycle, 6:18 day-dark cycle, 4:20 day-dark cycle, or 0:24 day-dark cycle. In a 16:8 day-dark cycle, the insects are maintained with 16 hours of light and 8 hours of darkness. In specific embodiments, the insets are maintained at 25° C. and at least about 75% relative humidity with a 16:8 day-dark cycle.

In certain embodiments, insects feeding on the diet solution containing an insecticidal agent of interest will not survive as long as they would survive on the same diet solution but without the insecticidal agent of interest. In these circumstances, the agent of interest can be evaluated as having insecticidal activity. As used herein, “insecticidal activity” of an agent refers to the ability of an agent, when consumed by a piercing or sucking insect in a diet solution, to prevent the insect from surviving as long as the insect would have survived consuming the same diet solution without the agent. Accordingly a “control diet solution” refers to a diet solution comprising a food source for keeping an insect alive, but without an insecticidal agent. Insecticidal activity can be measured by calculating the mortality % ([# insect deaths/total insects]×100), LD50, or LC50. The % mortality can be evaluated from day 2-25, day 3-12, day 5-10, or day 7-15 after addition to the feeding container, or each 3 days, each 4 days, each 5 days, each 6 days, or each 7 days. The day on which % mortality is evaluated can vary based on the insect species and the agent under evaluation.

An insecticidal agent by the method disclosed herein is also provided. In some embodiments, the selected agents have been evaluated by performing the method disclosed herein a single time. In other embodiment an agent is selected after being evaluated using the method disclosed herein multiple times, such as 1 repetition, 2 repetitions, 3 repetitions, 4 repetitions, 5 repetitions, 6 repetitions, 7 repetitions, 8 repetitions, 9 repetitions, 10 repetitions, 12 repetitions, 15 repetitions, or 20 repetitions of the evaluation method disclosed herein.

The article “a” and “an” are used herein to refer to one or more than one (i.e., to at least one) of the grammatical object of the article. By way of example, “an element” means one or more elements.

All publications and patent applications mentioned in the specification are indicative of the level of those skilled in the art to which this disclosure pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

Non-limiting embodiments include:

1. An apparatus for feeding piercing and sucking insects comprising a capillary tube having at least one feeding hole, an end closure, wherein said capillary tube contains a diet solution for a piercing or sucking insect.

2. The apparatus of embodiment 1, wherein the diet solution comprises sucrose.

3. The apparatus of embodiment 1 or 2, wherein the diet solution comprises a microbial culture, a cell lysate, or a protein.

4. The apparatus of embodiment 3, wherein the microbial culture or cell lysate comprises a protein having insecticidal activity against the piercing or sucking insect or the protein has insecticidal activity against the piercing or sucking insect.

5. The apparatus of any one of embodiments 1-4, wherein said diet solution comprises an antifungal agent.

6. The apparatus of any one of embodiments 1-5, wherein the capillary tube is closed at both ends.

7. The apparatus of any one of embodiments 1-6, wherein the capillary tube comprises at least 1, 2, 3, 4, 5, 6, 7, 8, 9 or 10 feeding holes.

8. The apparatus of embodiment 7, wherein the capillary tube comprises at least 2, 3, 4, 5, 6, 7, 8, 9 or 10 feeding holes, wherein the feeding holes are spaced 6-12 mm apart.

9. The apparatus of any one of embodiments 1-8, wherein each feeding hole is of a sufficient diameter as to maximize feeding of the piercing or sucking insect.

10. The apparatus of embodiment 9, wherein each feeding hole is from 0.5-2 mm in diameter.

11. The apparatus of any one of embodiments 1-10, wherein said capillary tube is within a feeding container.

12. A method for feeding a piercing or sucking insect, said method comprising placing at least one piercing or sucking insect in a feeding container, wherein the feeding container comprises a capillary tube having at least one feeding hole and an end closure, wherein said capillary tube contains a diet solution for a piercing or sucking insect.

13. The method of embodiment 12, wherein the diet solution comprises sucrose.

14. The method of embodiment 12 or 13, wherein the diet solution comprises a microbial culture, a cell lysate, or a protein.

15. The method of any one of embodiments 12-14, wherein the microbial culture or cell lysate comprises a protein having insecticidal activity against the piercing or sucking insect or the protein has insecticidal activity against the piercing or sucking insect.

16. The method of any one of embodiments 12-15, wherein said diet solution comprises an anti-fungal agent.

17. The method of any one of embodiments 12-16, wherein the capillary tube is closed at both ends.

18. The method of any one of embodiments 12-17, wherein the capillary tube comprises at least 1, 2, 3, 4, 5, 6, 7, 8, 9 or 10 feeding holes.

19. The method of embodiment 18, wherein the capillary tube comprises at least 2, 3, 4, 5, 6, 7, 8, 9 or 10 feeding holes, wherein the feeding holes are spaced 6-12 mm apart.

20. The method of any one of embodiments 12-19, wherein each feeding hole is of a sufficient diameter as to maximize feeding of the piercing or sucking insect.

21. The method of embodiment 20, wherein each feeding hole is from 0.5-2 mm in diameter.

22. The method of any one of embodiments 12-21, wherein the at least one piercing or sucking insect is placed in the feeding container using feathertip forceps or a vacuum aspirator.

23. The method of any one of embodiments 12-22, wherein 2-11 piercing or sucking insects are placed in the feeding container.

24. The method of embodiment 23, wherein the size of each piercing or sucking insect is within 70% of the size of the other piercing or sucking insects in the feeding container.

25. The method of any one of embodiments 12-24, wherein said at least one piercing or sucking insect is placed in the feeding container between the second instar stage and fifth instar stage.

26. The method of any one of embodiments 12-25, wherein said piercing or sucking insect is a Hemiptera insect.

27. The method of embodiment 26, wherein said Hemiptera insect is a Pentatomidae insect.

28. The method of embodiment 27, wherein said Pentatomidae insect is a green stink bug, brown marmorated stink bug, southern green stink bug, rice stink bug, or forest bug.

29. The method of any one of embodiments 12-28, further comprising maintaining the at least one piercing or sucking insect in the feeding container for about 6-14 days.

30. The method of embodiment 29, wherein about 0.1-1 mL of water is added to the feeding container every 2-6 days.

31. The method of embodiment 29 or 30, the method further comprising measuring the mortality after 3 days, after 4 days, after 5 days, after 6 days, after 7 days, after 8 days, after 9 days, after 10 days, after 11 days, and/or after 12 days.

The following examples are offered by way of illustration and not by way of limitation.

### Experimental

### EXAMPLE 1

### Southern Green Stink Bug Feeding Assay

The insect bioassay was performed with two replicates of five, 2nd instar Southern green stink bug (SGSB) nymphs per treatment. The bioassay unit is comprised of a filter-paper lined Petri dish that contains two capillary tubes filled with protein or microbe test substances in a liquid insect diet (10% sucrose in water). Capillary tubes (Globe Scientific Inc. Plastic microhematocrit capillary tube, plain, blue tip) were cut in half using a razor blade so that their final lengths were approximately 37.5 mm each. Four pinholes, approx. 8-9 mm apart, were added along one side of each capillary tube to provide locations for insects to feed using a teasing needle (BioQuip teasing needle, straight tip). 25 ul of each protein or microbe sample were pipetted into each capillary tube. The ends of each tube were then sealed with wax or a cap. Two capillary tubes were placed with their holes facing upward into a 60×15 mm Petri dish containing a filter pad moistened with 0.25 ml of the autoclaved diH2O. Five 2nd instar Southern green stink bugs were then added using feathertip forceps or a vacuum aspirator to the Petri dish before closing the dish with its lid. For each bioassay, appropriate positive and negative microbe or protein controls were tested alongside treatments. For each replicate, percent mortality was determined on days 6 and 8. When calculating the LC50 for a given microbe or protein, percent mortality was evaluated from days 5 through 10. For the duration of the bioassay, Petri dishes were stored in a controlled environmental chamber at 25° C. and >75% relative humidity with a 16:8 day:dark cycle.

TABLE 1
Mean percent mortality of second instar nymphal southern green
stink bugs provided protein treatments or a diet-only control
in capillary tubes. (n = 2 replicates of 10 stink bugs per treatment
and 20 stink bugs per replicate for the sucrose diet control)

| | Mean % mortality | | | | |
|---|---|---|---|---|---|
| Treatment (ppm) | Day 4 | Day 5 | Day 6 | Day 7 | Day 8 |
| Positive protein | 80 | 80 | 80 | 90 | 100 |
| control (9000) | | | | | |
| Positive protein | 70 | 90 | 100 | 100 | 100 |
| control (4000) | | | | | |
| Positive protein | 10 | 20 | 50 | 70 | 80 |
| control (2000) | | | | | |
| Positive protein | 0 | 10 | 20 | 20 | 20 |
| control (1000) | | | | | |
| Positive protein | 0 | 0 | 0 | 0 | 0 |
| control (500) | | | | | |
| Positive protein | 0 | 0 | 0 | 10 | 20 |
| control (250) | | | | | |
| sucrose diet | 0 | 0 | 0 | 10 | 15 |
| control (20 | | | | | |
| SGSB) | | | | | |

### EXAMPLE 2

### Lygus Bug Feeding Assay

The lygus bioassay was run with four replicates of five, 3rd instar Lygus bug nymphs per treatment. The bioassay unit contained a filter-paper lined Petri dish that contains three capillary tubes filled with protein or microbe test substances in a liquid insect diet (10% sucrose+amino acids in water). Bioassays were run using the same format as in Example 1 with the following modifications: Bioassays were scored for mortality on days 3, 5, and 7-post introduction of nymphs into bioassay units. Petri dishes were stored in a controlled environmental chamber at 25° C. and >75% relative humidity with a 16:8 day:dark cycle.

TABLE 2
Mean (±1 SEM) percent mortality of third instar nymphal Western
tarnished plant bugs, (Lygus hesperus) provided protein treatments
or a diet only control in capillary tubes. (n = 6 replicates of 5
Lygus bugs each per treatment and the diet control)

| | Mean % mortality | | |
|---|---|---|---|
| Treatment (ppm) | Day 3 | Day 5 | Day 7 |
| Positive protein | 43.3 ± 6.1 | 93.3 ± 4.2 | 100 ± 0.0 |
| control (2000) | | | |
| Negative protein | 6.7 ± 4.2 | 30.0 ± 8.6 | 70.0 ± 6.8 |
| control (2000) | | | |
| Buffer | 13.3 ± 4.2 | 20.0 ± 5.2 | 43.3 ± 6.1 |
| (negative control) | | | |
| Diet only control | 6.7 ± 4.2 | 13.3 ± 4.2 | 40.0 ± 7.3 |

That which is claimed:

1. An apparatus for feeding piercing and sucking insects comprising a capillary tube having at least one feeding hole, an end closure, wherein said capillary tube contains a diet solution for a piercing or sucking insect.

2. The apparatus of claim 1, wherein the diet solution comprises sucrose.

3. The apparatus of claim 1 or 2, wherein the diet solution comprises a microbial culture, a cell lysate, or a protein.

4. The apparatus of claim 3, wherein the microbial culture or cell lysate comprises a protein having insecticidal activity against the piercing or sucking insect or the protein has insecticidal activity against the piercing or sucking insect.

5. The apparatus of any one of claims 1-4, wherein said diet solution comprises an antifungal agent.

6. The apparatus of any one of claims 1-5, wherein the capillary tube is closed at both ends.

7. The apparatus of any one of claims 1-6, wherein the capillary tube comprises at least 1, 2, 3, 4, 5, 6, 7, 8, 9 or 10 feeding holes.

8. The apparatus of claim 7, wherein the capillary tube comprises at least 2, 3, 4, 5, 6, 7, 8, 9 or 10 feeding holes, wherein the feeding holes are spaced 6-12 mm apart.

9. The apparatus of any one of claims 1-8, wherein each feeding hole is of a sufficient diameter as to maximize feeding of the piercing or sucking insect.

10. The apparatus of claim 9, wherein each feeding hole is from 0.5-2 mm in diameter.

11. The apparatus of any one of claims 1-10, wherein said capillary tube is within a feeding container.

12. A method for feeding a piercing or sucking insect, said method comprising placing at least one piercing or sucking insect in a feeding container, wherein the feeding container comprises a capillary tube having at least one feeding hole and an end closure, wherein said capillary tube contains a diet solution for a piercing or sucking insect.

13. The method of claim 12, wherein the diet solution comprises sucrose.

14. The method of claim 12 or 13, wherein the diet solution comprises a microbial culture, a cell lysate, or a protein.

15. The method of claim 12-14, wherein the microbial culture or cell lysate comprises a protein having insecticidal activity against the piercing or sucking insect or the protein has insecticidal activity against the piercing or sucking insect.

16. The method of any one of claims 12-15, wherein said diet solution comprises an anti-fungal agent.

17. The method of any one of claims 12-16, wherein the capillary tube is closed at both ends.

18. The method of any one of claims 12-17, wherein the capillary tube comprises at least 1, 2, 3, 4, 5, 6, 7, 8, 9 or 10 feeding holes.

19. The method of claim 18, wherein the capillary tube comprises at least 2, 3, 4, 5, 6, 7, 8, 9 or 10 feeding holes, wherein the feeding holes are spaced 6-12 mm apart.

20. The method of any one of claims 12-19, wherein each feeding hole is of a sufficient diameter as to maximize feeding of the piercing or sucking insect.

21. The method of claim 20, wherein each feeding hole is from 0.5-2 mm in diameter.

22. The method of any one of claims 12-21, wherein the at least one piercing or sucking insect is placed in the feeding container using feathertip forceps or a vacuum aspirator.

23. The method of any one of claims 12-22, wherein 2-11 piercing or sucking insects are placed in the feeding container.

24. The method of claim 23, wherein the size of each piercing or sucking insect is within 70% of the size of the other piercing or sucking insects in the feeding container.

25. The method of any one of claims 12-24, wherein said at least one piercing or sucking insect is placed in the feeding container between the second instar stage and fifth instar stage.

26. The method of any one of claims 12-25, wherein said piercing or sucking insect is a Hemiptera insect.

27. The method of claim 26, wherein said Hemiptera insect is a Pentatomidae insect.

28. The method of claim 27, wherein said Pentatomidae insect is a green stink bug, brown marmorated stink bug, southern green stink bug, rice stink bug, or forest bug.

29. The method of any one of claims 12-28, further comprising maintaining the at least one piercing or sucking insect in the feeding container for about 6-14 days.

30. The method of claim 29, wherein about 0.1-1 mL of water is added to the feeding container every 2-6 days.

31. The method of claim 29 or 30, the method further comprising measuring the mortality after 3 days, after 4 days, after 5 days, after 6 days, after 7 days, after 8 days, after 9 days, after 10 days, after 11 days, and/or after 12 days.
